(19) United States
(12) Patent Application Publication
(10) Pub. No.: US 2026/0356684 A1
(43) Pub. Date: Nov. 12, 2026

(54) PROCESS FOR EXTRACTION OF RARE EARTH ELEMENTS

(71) Applicant: CENTRAL AMERICA NICKEL INC., Montréal (CA)

(72) Inventors: Richard BOUDREAULT, Montréal (CA); Pierre GAUTHIER, Montréal (CA); Daria Camilla BOFFITO, Montréal (CA)

(21) Appl. No.: 19/121,744

(22) PCT Filed: Oct. 19, 2023
(86) PCT No.: PCT/CA2023/051387

§ 371 Date: Apr. 16, 2025

Related U.S. Application Data
(60) Provisional application No. 63/380,259, filed on Oct. 20, 2022.

(51) Int. Cl. C01F 17/224; C22B 3/06; C22B 3/22; C22B 3/44; C22B 7/00; C22B 59/00; C22B 60/02

(52) U.S. Cl. CPC C01F 17/224; C22B 3/06; C22B 3/22; C22B 3/44; C22B 7/007; C22B 59/00; C22B 60/0291; C22B 60/0295

(57) ABSTRACT

A process for the extraction and recovery of rare earth elements is described herein. More specifically, the process comprises leaching the rare earth element-containing material in an acidic solution while simultaneously sonicating the acidic solution thereby producing a pregnant solution; raising the pH of the pregnant solution to about 3 providing for the precipitation of a radionuclide salt from the pregnant solution and producing a substantially radionuclide depleted pregnant solution; raising the pH of the substantially radionuclide depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides. A process for the selective extraction/separation of radionuclides from other rare earth elements is also disclosed.

### CROSS REFERENCE TO RELATED APPLICATIONS

This application claims the benefit of U.S. Provisional Application 63/380,259, filed Oct. 20, 2022. The contents of the referenced application are incorporated into the present application by reference.

### BACKGROUND

### 1. Field

This disclosure relates to the field of chemistry. More specifically, but not exclusively, the present disclosure broadly relates to a process for the extraction and recovery of rare earth elements. Yet more specifically, the present disclosure relates to a process for the extraction and recovery of rare earth elements using ultrasound assisted extraction. The present disclosure also relates to the selective extraction/separation of radionuclides from other rare earth elements.

### 2. Related Art

The following discussion of the background art is only intended to facilitate an understanding of the process described herein.

Rare earth elements (REEs) are essential components of current and emerging 21^{st} century technologies. Recent concern about future supplies of all the REEs has now narrowed chiefly to the heavy rare earth elements (HREEs). Essentially, all of the world's HREEs are currently sourced from the south China ion-adsorption clay deposits. The ability of those deposits to maintain and increase production is uncertain, particularly in light of environmental degradation associated with some mining and extraction operations in the region.

Rare earth elements (REEs) comprise seventeen elements in the periodic table, specifically the 15 lanthanide elements in addition to scandium and yttrium. The lanthanide series of chemical elements comprises the chemical elements with atomic numbers 57 through 71, from lanthanum through lutetium. REEs are a group of metallic elements with unique chemical, catalytic, magnetic, conductive, spectroscopic, metallurgical, and phosphorescent properties, and as such find use in a wide variety of modern devices including high-strength magnets, batteries, displays, lighting, medical and nuclear devices, and high performance metal alloys. Rare earth elements are profoundly valuable and are critical in the manufacture of electronics (e.g., microchips, semiconductors, in essence any product with a computer chip). China presently occupies a dominant position in the REE market; approximately 90% of REE purification being performed in China.

REEs are relatively plentiful in the earth's crust. However, REEs are typically highly dispersed and are not often found as concentrated rare earth minerals in economically exploitable ore deposits. There are plenty of REE deposits around the globe, particularly at asteroid impact sites such as in Vichada, Columbia. Three minerals, monazite, basnasite and xenotime, make up 95% of the world's REE reserves. The REEs can be found in monazite sand deposits near the surface or in the more deeply encrusted ore deposits. Monazite is a primarily reddish brown phosphate mineral [(Ce,La,Nd,Th)PO₄], the major commercial source of Ce. Monazite contains about 70% rare earth oxides, and are known to be particularly rich in valuable rare earths such as neodymium, praseodymium and samarium. Monazites occur as small heavy crystals in granitic and gneissic rocks and their detritus (called monazite sands). Monazite may contain up to 27 wt. % of U and Th oxides. Depending on the relative amounts of the rare earth elements in the mineral, there are several common species of monazite, the five main ones being: monazite—(Ce), (Ce,La,Nd,Th)PO₄ (the most common member); monazite—(La), (La,Ce,Nd)PO₄; monazite—(Nd), (Nd,La,Ce)PO₄; monazite—(Sm), (Sm,Gd,Ce,Th)PO₄; and monazite—(Pr), (Pr,Ce,Nd,Th)PO₄.

REEs may be further categorized based upon their value and/or their molecular weight. The critical rare earth elements (“CREEs”) include neodymium (Nd), europium (Eu), terbium (Tb), dysprosium (Dy), praseodymium (Pr) and yttrium (Y). The heavy rare earth elements (“HREEs”) include samarium (Sm), europium (Eu), gadolinium (Gd) terbium (Tb), dysprosium (Dy), holmium (Ho), erbium (Er), thulium (Tm), ytterbium (Y) and lutetium (Lu). The light rare earth elements (“LREE”) refer to lanthanum (La), cerium (Ce), praseodymium (Pr) and neodymium (Nd).

The lighter rare earth elements such as lanthanum, cerium, praseodymium, and neodymium are more abundant and concentrated and usually make up about 80%-99% of a total ore deposit. The heavier elements (Gd—Lu), which are on average 8-125 times more expensive than the light rare earth metals (lanthanides), are less abundant but higher in demand.

The extraction of REEs from mineral deposits is also challenging because mineral deposits containing REEs typically also contain appreciable levels of radioactive elements such as thorium (Th) and uranium (U) that must be safely and economically separated from the REEs during processing of the ore. Moreover, the separation of the rare earth elements (metals) from the ore materials constitutes a significant environmental problem. One of the major problems with conventional REE extraction is its extreme toxicity to both the environment and humans. Only a few countries (e.g., China) have approved the construction of conventional REE extraction plants.

Historically separation of rare earth metals can be divided into four main groups such as chemical separation, fractional crystallizations, ion-exchange methods and solvent extraction. Apart from the initial chemical separation of cerium and repeated fractional crystallization (time-consuming), nowadays only solvent extraction and ion-exchange methods are used on a commercial scale. Ion-exchange chromatography methods of separation, but for electronic or spectroscopic use, is not of real commercial importance for large-scale production (disadvantage of being a slow process).

The most popular method to extract REEs from monazite is wet digestion. However, ore grade monazite is notoriously difficult to leach due to the stability of the phosphate crystal and requires high temperatures, long leaching times and pressures to break down. The two most common methods of monazite leaching are: (1) NaOH leaching and (2) H₂SO₄ digestion followed by cold water leaching. The leaching reagent chosen varies with costs and availability. The traditional sulfuric acid digestion system requires temperatures of 200-300 °C for two-four hours and but yields recoveries of greater than 99%. Currently, studies aimed at direct leaching of monazite using sulfuric acid at milder conditions (room temperature, low acid concentrations, short leaching times) have yielded low extraction efficiencies.

Solvent extraction is recognized as an important industrial technology for separation and purification of rare earth elements. Acidic organophosphorus extractants, such as tributyl phosphate or di-2-ethylhexyl phosphoric acid D2EHPA), are widely used for this purpose. Industrially the rare earths are usually recovered from the leach liquor by solvent extraction with 25% D2EHPA in kerosene, followed by multistage recovery of the rare earths from the organic solution and precipitation with oxalic acid. The final step is calcination and transformation of the rare-earth oxalates into oxides. The disadvantages of this approach include the complexity of the process and large scale use of hazardous chemicals (e.g., organophosphorus compounds).

A novel process for the extraction and separation of REE in high yield and purity, that is of an environmentally cleaner design, and overcoming the technical and economic limitations of the existing commercial processes is of commercial interest.

### SUMMARY

The present disclosure broadly relates to a process for the extraction and recovery of rare earth elements. In an aspect of the present disclosure, the process for the extraction and recovery of rare earth elements comprises an ultrasound assisted extraction step. In a further aspect of the present disclosure, the process for the extraction and recovery of rare earth elements comprises leaching a rare earth element-containing material in an acidic solution while simultaneously sonicating the acidic solution. The present disclosure also relates to a process for the selective extraction/separation of radionuclides from other rare earth elements.

In an aspect, the present disclosure relates to a process for extracting one or more rare earth elements from a rare earth element-containing material, the process comprising: leaching the rare earth element-containing material in an acidic solution while simultaneously sonicating the acidic solution thereby producing a pregnant solution; raising the pH of the pregnant solution to about 3 providing for the precipitation of a radionuclide salt from the pregnant solution and producing a substantially radionuclide depleted pregnant solution; raising the pH of the substantially radionuclide depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides.

In an aspect, the present disclosure relates to a process for separating a radionuclide from an acidic solution comprising the radionuclide and at least one or more rare earth elements, the process comprising: raising the pH of the acidic solution to about 3 providing for the precipitation of a radionuclide salt from the acidic solution, and producing a substantially radionuclide depleted acidic solution; wherein the acidic solution is obtained by leaching a rare earth element-containing material in an acidic acid solution while simultaneously sonicating (i.e. using ultrasound) the acidic solution, thereby producing the acidic solution. In an embodiment, the process further comprises raising the pH of the substantially radionuclide depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides. In a further embodiment, the radionuclide comprises thorium.

In an aspect, the present disclosure relates to a process for extracting one or more rare earth elements from an acidic solution, the process comprising: raising the pH of the acidic solution to about 3 providing for the precipitation of a radionuclide salt from the acidic solution, and producing a substantially radionuclide depleted acidic solution; wherein the acidic solution is obtained by leaching a rare earth element-containing material in an acidic acid solution while simultaneously sonicating the acidic solution thereby producing the acidic solution. In an embodiment, the process further comprises raising the pH of the substantially radionuclide depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides. In an embodiment of the present disclosure, the treatment with a carbonate source is advantageously performed when a pH ranging from about 9 to about 10 is reached.

In an aspect, the present disclosure relates to a process for extracting one or more rare earth elements from a rare earth element-containing material, the process comprising: processing the rare earth element containing material producing a processed material; leaching the processed material in an acidic acid solution while simultaneously sonicating the acidic solution thereby producing a pregnant solution; raising the pH of the pregnant solution to about 3 providing for the precipitation of a radionuclide salt from the pregnant solution and producing a substantially radionuclide depleted pregnant solution; raising the pH of the substantially radionuclide depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides.

In an aspect of the present disclosure, the leaching/sonication of the rare earth-element containing material may be repeated at least a second time, at the same or a different sonication frequency, acid concentration, amplitude and/or temperature.

Also disclosed in the context of the present disclosure are embodiments 1 to 99. Embodiment 1 is a process for extracting one or more rare earth elements from a rare earth element-containing material, the process comprising: leaching the rare earth element-containing material in an acidic solution while simultaneously sonicating the acidic solution thereby producing a pregnant solution; raising the pH of the pregnant solution to about 3 providing for the precipitation of a radionuclide salt from the pregnant solution and producing a substantially radionuclide depleted pregnant solution; raising the pH of the substantially radionuclide depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides. Embodiment 2 is the process of embodiment 1, wherein the sonication is performed at a frequency ranging from about 20 to about 200 kHz and an amplitude ranging from 1% to 100%. Embodiment 3 is the process of embodiment 1 or 2, wherein the leaching is performed at temperatures ranging between about 20 °C and about 200 °C. Embodiment 4 is the process of any one of embodiments 1 to 3, wherein the radionuclide is at least one of thorium or uranium. Embodiment 5 is the process of any one of embodiments 1 to 4, further comprising subjecting the rare earth element-containing material to at least one beneficiation step prior to the leaching to remove any gangue material. Embodiment 6 is the process of embodiment 5, wherein the at least one beneficiation step comprises separation based on optical and magnetic properties, sensor-based sorting, flotation, gravity separation, and comminuting, crushing or grinding. Embodiment 7 is the process of any one of embodiments 1 to 6, further comprising separating the rare earth carbonates into light and heavy rare earth carbonates. Embodiment 8 is the process of embodiment 7, wherein the light rare earth carbonates comprise Y₂(CO₃)₃, La₂(CO₃)₃, Ce₂(CO₃)₃, Pr₂(CO₃)₃, and hydrates thereof. Embodiment 9 is the process of embodiment 7, wherein the heavy rare earth carbonates comprise Yb₂(CO₃)₃, Nd₂(CO₃)₃, Sm₂(CO₃)₃, Dy₂(CO₃)₃, Gd₂(CO₃)₃, and Er₂(CO₃)₃, and hydrates thereof. Embodiment 10 is the process of any one of embodiments 7 to 9, wherein the separating is performed by centrifugation. Embodiment 11 is the process of any one of embodiments 1 to 10, wherein the source of carbonate comprises CO₂ gas or a carbonate salt. Embodiment 12 is the process of embodiment 11, wherein the carbonate salt is one or more of sodium carbonate (Na₂CO₃), lithium carbonate (Li₂CO₃), or calcium carbonate (CaCO₃). Embodiment 13 is the process of any one of embodiments 1 to 12, wherein the oxidizing of the rare earth carbonates comprises calcination of the rare earth carbonates. Embodiment 14 is the process of embodiment 13, wherein the calcination is performed at temperatures between about 500 °C and about 1200 °C. Embodiment 15 is the process of any one of embodiments 1 to 14, wherein the selectively separating the rare earth oxides is performed by at least one of solvent extraction, magnetic separation, or electrostatic separation. Embodiment 16 is the process of any one of embodiments 1 to 15, wherein the rare earth element-containing material comprises rare-earth element bearing ore materials, mine tailings, waste coal ash, or industrial waste materials. Embodiment 17 is the process of any one of embodiments 1 to 16, wherein the acidic solution is at least one of a sulfuric acid solution, a hydrochloric acid solution, a nitric acid solution, a carbonic acid solution, or a combination of any thereof. Embodiment 18 is the process of any one of embodiments 1 to 17, wherein the radionuclide salt is at least one of thorium sulfate, uranium sulfate, thorium chloride, uranium chloride, thorium nitrate, uranium nitrate, and hydrates thereof. Embodiment 19 is the process of any one of embodiments 1 to 18, further comprising removing phosphates from the pregnant solution. Embodiment 20 is the process of embodiment 19, wherein phosphate removal is performed by raising the pH of the pregnant solution to not greater than 3 to avoid precipitation of the radionuclide salt from the pregnant solution. Embodiment 21 is the process of embodiment 5, wherein the gangue material comprises at least one of iron, silicon, tin, phosphate or tantalum. Embodiment 22 is the process of any one of embodiments 1 to 21, wherein the sonication is performed using an external sonication probe. Embodiment 23 is the process of any one of embodiments 1 to 21, wherein the sonication is performed using an internal sonication probe.

Embodiment 24 is a process for separating thorium from an acidic solution comprising thorium and at least one or more rare earth elements, the process comprising: raising the pH of the acidic solution to about 3 providing for the precipitation of a thorium salt from the acidic solution, and producing a substantially thorium depleted acidic solution; wherein the acidic solution is obtained by leaching a rare earth element-containing material while simultaneously sonicating the acidic solution, thereby producing the acidic solution. Embodiment 25 is the process of embodiment 24, further comprising: raising the pH of the substantially thorium depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides. Embodiment 26 is the process of embodiment 24 or 25, wherein the sonication is performed at a frequency ranging from about 20 to about 200 kHz and an amplitude ranging from 1% to 100%. Embodiment 27 is the process of any one of embodiments 24 to 26, wherein the leaching is performed at temperatures ranging between about 20 °C and about 200 °C. Embodiment 28 is the process of any one of embodiments 24 to 27, further comprising subjecting the rare earth element-containing material to at least one beneficiation step prior to the leaching to remove any gangue material. Embodiment 29 is the process of embodiment 28, wherein the at least one beneficiation step comprises separation based on optical and magnetic properties, sensor-based sorting, flotation, gravity separation, and comminuting, crushing or grinding. Embodiment 30 is the process of embodiment 25, further comprising separating the rare earth carbonates into light and heavy rare earth carbonates. Embodiment 31 is the process of embodiment 30, wherein the light rare earth carbonates comprise Y₂(CO₃)₃, La₂(CO₃)₃, Ce₂(CO₃)₃, Pr₂(CO₃)₃, and hydrates thereof. Embodiment 32 is the process of embodiment 30, wherein the heavy rare earth carbonates comprise Yb₂(CO₃)₃, Nd₂(CO₃)₃, Sm₂(CO₃)₃, Dy₂(CO₃)₃, Gd₂(CO₃)₃, Er₂(CO₃)₃ and hydrates thereof. Embodiment 33 is the process of any one of embodiments 30 to 32, wherein the separating is performed by centrifugation. Embodiment 34 is the process of embodiment 25, wherein the source of carbonate comprises CO₂ gas or a carbonate salt. Embodiment 35 is the process of embodiment 34, wherein the carbonate salt is one or more of sodium carbonate (Na₂CO₃), lithium carbonate (Li₂CO₃), or calcium carbonate (CaCO₃). Embodiment 36 is the process of embodiment 25, wherein the oxidizing of the rare earth carbonates comprises calcination of the rare earth carbonates. Embodiment 37 is the process of embodiment 36, wherein the calcination is performed at temperatures between about 500 °C and about 1200 °C. Embodiment 38 is the process of embodiment 25, wherein the selectively separating the rare earth oxides is performed by at least one of solvent extraction, magnetic separation, or electrostatic separation. Embodiment 39 is the process of any one of embodiments 24 to 38, wherein the rare earth element-containing material comprises rare-earth element bearing ore materials, mine tailings, waste coal ash, or industrial waste materials. Embodiment 40 is the process of any one of embodiments 24 to 39, wherein the acidic solution is at least one of a sulfuric acid solution, a hydrochloric acid solution, a nitric acid solution, a carbonic acid solution, or a combination of any thereof. Embodiment 41 is the process of any one of embodiments 24 to 40, wherein the thorium salt is at least one of thorium sulfate, thorium chloride, thorium nitrate, or hydrates thereof. Embodiment 42 is the process of embodiment 25, further comprising removing phosphates from the acidic solution. Embodiment 43 is the process of embodiment 42, wherein phosphate removal is performed by raising the pH of the acidic solution to not greater than 3 to avoid precipitation of the thorium salt from the acidic solution. Embodiment 44 is the process of embodiment 28, wherein the gangue material comprises at least one of iron, silicon, tin, phosphate or tantalum. Embodiment 45 is the process of any one of embodiments 24 to 44, wherein raising the pH of the acidic solution to about 3 further provides for the precipitation of a uranium salt from the acidic solution. Embodiment 46 is the process of embodiment 45, wherein the uranium salt is at least one of uranium sulfate, uranium chloride, uranium nitrate, or hydrates thereof. Embodiment 47 is the process of any one of embodiments 24 to 46, wherein the sonication is performed using an external sonication probe. Embodiment 48 is the process of any one of embodiments 24 to 46, wherein the sonication is performed using an internal sonication probe.

Embodiment 49 is a process for extracting one or more rare earth elements from an acidic solution, the process comprising: raising the pH of the acidic solution to about 3 providing for the precipitation of a radionuclide salt from the acidic solution, and producing a substantially radionuclide depleted acidic solution; wherein the acidic solution is obtained by leaching a rare earth element-containing material in an acidic acid solution while simultaneously sonicating the acidic solution thereby producing the acidic solution. Embodiment 50 is the process of embodiment 49, further comprising: raising the pH of the substantially radionuclide depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides. Embodiment 51 is the process of embodiment 49 or 50, wherein the sonication is performed at a frequency ranging from about 20 to about 200 kHz and an amplitude ranging from 1% to 100%. Embodiment 52 is the process of any one of embodiments 49 to 51, wherein the leaching is performed at temperatures between about 20 °C and about 200 °C. Embodiment 53 is the process of any one of embodiments 49 to 52, wherein the radionuclide is at least one of thorium or uranium. Embodiment 54 is the process of any one of embodiments 49 to 53, further comprising subjecting the rare earth element-containing material to at least one beneficiation step prior to the leaching to remove any gangue material. Embodiment 55 is the process of embodiment 54, wherein the at least one beneficiation step comprises separation based on optical and magnetic properties, sensor-based sorting, flotation, gravity separation, and comminuting, crushing or grinding. Embodiment 56 is the process of embodiment 50, further comprising separating the rare earth carbonates into light and heavy rare earth carbonates. Embodiment 57 is the process of embodiment 56, wherein the light rare earth carbonates comprise Y₂(CO₃)₃, La₂(CO₃)₃, Ce₂(CO₃)₃, Pr₂(CO₃)₃, and hydrates thereof. Embodiment 58 is the process of embodiment 57, wherein the heavy rare earth carbonates comprise Yb₂(CO₃)₃, Nd₂(CO₃)₃, Sm₂(CO₃)₃, Dy₂(CO₃)₃, Gd₂(CO₃)₃, Er₂(CO₃)₃, and hydrates thereof. Embodiment 59 is the process of any one of embodiments 56 to 58, wherein the separating is performed by centrifugation. Embodiment 60 is the process of embodiment 50, wherein the source of carbonate comprises CO₂ gas or a carbonate salt. Embodiment 61 is the process of embodiment 60, wherein the carbonate salt is one or more of sodium carbonate (Na₂CO₃), lithium carbonate (Li₂CO₃), or calcium carbonate (CaCO₃). Embodiment 62 is the process of embodiment 50, wherein the oxidizing of the rare earth carbonates comprises calcination of the rare earth carbonates. Embodiment 63 is the process of embodiment 62, wherein the calcination is performed at temperatures between about 500 °C and about 1200 °C. Embodiment 64 is the process of embodiment 50, wherein the selectively separating the rare earth oxides is performed by at least one of solvent extraction, magnetic separation, or electrostatic separation. Embodiment 65 is the process of any one of embodiments 49 to 64, wherein the rare earth element-containing material comprises rare-earth element bearing ore materials, mine tailings, waste coal ash, or industrial waste materials. Embodiment 66 is the process of any one of embodiments 49 to 65, wherein the acidic solution is at least one of a sulfuric acid solution, a hydrochloric acid solution, a nitric acid solution, a carbonic acid solution, or a combination of any thereof. Embodiment 67 is the process of any one of embodiments 49 to 66, wherein the radionuclide salt is at least one of thorium sulfate, uranium sulfate, thorium chloride, uranium chloride, thorium nitrate or uranium nitrate, and hydrates thereof. Embodiment 68 is the process of any one of embodiments 49 to 67, further comprising removing phosphates from the pregnant solution. Embodiment 69 is the process of embodiment 68, wherein phosphate removal is performed by raising the pH of the substantially radionuclide depleted acidic solution to not greater than 3 to avoid precipitation of the radionuclide salt from the pregnant solution. Embodiment 70 is the process of embodiment 54, wherein the gangue material comprises at least one of iron, silicon, tin, phosphate or tantalum. Embodiment 71 is the process of any one of embodiments 49 to 70, wherein the sonication is performed using an external sonication probe. Embodiment 72 is the process of any one of embodiments 49 to 70, wherein the sonication is performed using an internal sonication probe.

Embodiment 73 is a process for extracting one or more rare earth elements from a rare earth element-containing material, the process comprising: processing the rare earth element containing material producing a processed material; leaching the processed material in an acidic solution while simultaneously sonicating the acidic solution thereby producing a pregnant solution; raising the pH of the pregnant solution to about 3 providing for the precipitation of a radionuclide salt from the pregnant solution and producing a substantially radionuclide depleted pregnant solution; raising the pH of the substantially radionuclide depleted pregnant solution to about 9 and treating the solution with a source of carbonate to provide a precipitate comprising one or more rare earth carbonates; oxidizing the one or more rare earth carbonates producing one or more rare earth oxides; and selectively separating the one or more rare earth oxides. Embodiment 74 is the process of embodiment 73, wherein the sonication is performed at a frequency ranging from about 20 to about 200 kHz and an amplitude ranging from 1% to 100%. Embodiment 75 is the process of embodiment 73 or 74, wherein the leaching is performed at temperatures between about 20 °C and about 200 °C. Embodiment 76 is the process of any one of embodiments 73 to 75, wherein the radionuclide is at least one of thorium or uranium. Embodiment 77 is the process of any one of embodiments 73 to 76, wherein the processing comprises subjecting the rare earth element-containing material to at least one beneficiation step prior to the leaching to remove any gangue material. Embodiment 78 is the process of embodiment 77, wherein the at least one beneficiation step comprises separation based on optical and magnetic properties, sensor-based sorting, flotation, gravity separation, and comminuting, crushing or grinding. Embodiment 79 is the process of any one of embodiments 73 to 78, further comprising separating the rare earth carbonates into light and heavy rare earth carbonates. Embodiment 80 is the process of embodiment 79, wherein the light rare earth carbonates comprise Y₂(CO₃)₃, La₂(CO₃)₃, Ce₂(CO₃)₃, Pr₂(CO₃)₃, and hydrates thereof. Embodiment 81 is the process of embodiment 80, wherein the heavy rare earth carbonates comprise Yb₂(CO₃)₃, Nd₂(CO₃)₃, Sm₂(CO₃)₃, Dy₂(CO₃)₃, Gd₂(CO₃)₃, Er₂(CO₃)₃, and hydrates thereof. Embodiment 82 is the process of any one of embodiments 79 to 81, wherein the separating is performed by centrifugation. Embodiment 83 is the process of any one of embodiments 73 to 82, wherein the source of carbonate comprises CO₂ gas or a carbonate salt. Embodiment 84 is the process of embodiment 83, wherein the carbonate salt is one or more of sodium carbonate (Na₂CO₃), lithium carbonate (Li₂CO₃), or calcium carbonate (CaCO₃). Embodiment 85 is the process of any one of embodiments 73 to 84, wherein the oxidizing of the rare earth carbonates comprises calcination of the rare earth carbonates. Embodiment 86 is the process of embodiment 85, wherein the calcination is performed at temperatures between about 500 °C and about 1200 °C. Embodiment 87 is the process of any one of embodiments 73 to 86, wherein the selectively separating the rare earth oxides is performed by at least one of solvent extraction, magnetic separation, or electrostatic separation. Embodiment 88 is the process of any one of embodiments 73 to 87, wherein the rare earth element-containing material comprises rare-earth element bearing ore materials, mine tailings, waste coal ash, or industrial waste materials. Embodiment 89 is the process of any one of embodiments 73 to 88, wherein the acidic solution is at least one of a sulfuric acid solution, a hydrochloric acid solution or a nitric acid solution, a carbonic acid solution, or a combination of any thereof. Embodiment 90 is the process of any one of embodiments 73 to 89, wherein the radionuclide salt is at least one of thorium sulfate, uranium sulfate, thorium chloride, uranium chloride, thorium nitrate or uranium nitrate, and hydrates thereof. Embodiment 91 is the process of any one of embodiments 73 to 90, further comprising removing phosphates from the pregnant solution. Embodiment 92 is the process of embodiment 91, wherein phosphate removal is performed by raising the pH of the pregnant solution to not greater than 3 to avoid precipitation of the radionuclide salt from the pregnant solution. Embodiment 93 is the process of embodiment 77, wherein the gangue material comprises at least one of iron, silicon, tin, phosphate or tantalum. Embodiment 94 is the process of any one of embodiments 73 to 93, wherein the sonication is performed using an external sonication probe. Embodiment 95 is the process of any one of embodiments 73 to 93, wherein the sonication is performed using an internal sonication probe. Embodiment 96 is the process of any one of embodiments 1 to 95, wherein the rare earth element is at least one of scandium (Sc), yttrium (Y), lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), Erbium (Er), thulium (Tm), ytterbium (Yb), or lutetium (Lu). Embodiment 97 is the process of embodiment 96, wherein the rare earth element-containing material may further comprise a transition metal. Embodiment 98 is the process of embodiment 96 or 97, wherein the rare earth element-containing material may further comprise an actinide metal. Embodiment 99 is the process of any one of embodiments 1 or 98, wherein the rare earth element-containing material comprises a monazite ore material, bastnasite ore material, apatite ore material, or any combination thereof.

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this specification and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The foregoing and other advantages and features of the present disclosure will become more apparent upon reading of the following non-restrictive detailed description of illustrative embodiments thereof, with reference to the accompanying drawings/figures. It should be understood, however, that the detailed description and the illustrative embodiments, while indicating specific embodiments of the disclosure, are given by way of illustration only, since various changes and modifications within the spirit and scope of the disclosure will become apparent to those skilled in the art from this description.

### BRIEF DESCRIPTION OF THE DRAWINGS/FIGURES

The following figures/drawings form part of the present specification and are included to further demonstrate certain aspects of the present specification. The present specification may be better understood by reference to one or more of these figures/drawings in combination with the detailed description. In the appended drawings/figures:

FIG. 1—Illustration of a flowchart broadly depicting the process for the extraction and recovery of rare earth elements from a REE containing ore material, in accordance with an embodiment of the present disclosure.

FIG. 2—Illustration of an experimental plot illustrating the recovery percentage of various rare earth elements as a function of pH, in accordance with an embodiment of the present disclosure.

FIG. 3—Illustration of an experimental plot illustrating the recovery percentage of various rare earth elements as a function of pH using NH₄OH as the alkaline material, in accordance with an embodiment of the present disclosure.

FIG. 4—Illustration of an experimental plot illustrating the recovery percentage of various rare earth elements as a function of pH using NaOH as the alkaline material, in accordance with an embodiment of the present disclosure.

FIG. 5—Illustration of a flowchart illustrating the pre-processing section of the process for the extraction and recovery of rare earth elements, in accordance with an embodiment of the present disclosure.

FIG. 6—Illustration of a flowchart illustrating the processing section of the process for the extraction and recovery of rare earth elements, in accordance with an embodiment of the present disclosure.

FIG. 7—Illustration of a flowchart illustrating the post-processing section of the process for the extraction and recovery of rare earth elements, in accordance with an embodiment of the present disclosure.

FIG. 8—Illustration of an experimental plot illustrating the recovery of selected rare earth elements from Congo monazite feed material following nitric acid leaching/sonication, in accordance with an embodiment of the present disclosure.

FIG. 9—Illustration of an experimental sono-chemical leaching setup in accordance with an embodiment of the present disclosure: Ultrasound generator (1); Air inlet (2); Sonotrode (3); Jacketed reactor (4); Water inlet (5); Water outlet (6); Thermostatic water bath (7); Magnetic stirring plate (8).

FIG. 10—Illustration of an experimental plot illustrating the effect of leaching time on rare earth element extraction in accordance with an embodiment of the present disclosure. The leaching performance was evaluated at 10, 30 and 60 minutes respectively, using H₂SO₄ (40% m/m), a slurry temperature of 60 °C, a liquid/solid (L/S) ratio of 7, and an ultrasound power output of 94 W (top section). The leaching performance was also evaluated at 10, 30 and 60 minutes respectively, using H₂SO₄ (40% w/w), a slurry temperature of 60 °C, a liquid/solid (L/S) ratio of 7, but without the assistance of ultrasound (bottom section).

FIG. 11—Illustration of an experimental plot illustrating the effect of acid concentration on rare earth element extraction in accordance with an embodiment of the present disclosure. The leaching performance was evaluated for H₂SO₄ concentrations ranging between 36% and 98% (m/m), a slurry temperature of 60 °C, a leaching time of 30 minutes, a liquid/solid (L/S) ratio of 7, and an ultrasound power output of 94 W.

FIG. 12—Illustration of the leaching efficiency with or without the use of sonication in accordance with an embodiment of the present disclosure. The leaching was conducted using H₂SO₄ 98% (m/), a slurry temperature of 60 °C, a leaching time of 30 minutes, a liquid/solid (L/S) ratio of 7, and an ultrasound power output of 94 W. The leaching with sonication advantageously provides for at least a 33% extraction improvement for all REEs evaluated.

FIG. 13—Illustration of an experimental plot illustrating the effect of the ultrasound power output on rare earth element extraction in accordance with an embodiment of the present disclosure. The leaching performance was evaluated at ultrasound power outputs ranging between 78 W and 116 W, using H₂SO₄ (40% w/w), a slurry temperature of 60 °C, a liquid/solid (L/S) ratio of 7, and a leaching time of 30 minutes.

FIG. 14—Illustration of an SEM image of a monazite residue following sonication at a power setting of 102 W (a), and 116 W (b).

FIG. 15—Illustration of an experimental plot illustrating the effect of the liquid/solid (L/S) ratio on rare earth element extraction in accordance with an embodiment of the present disclosure. The leaching performance was evaluated at L/S ratios ranging from 3:1 to 9:1, using H₂SO₄ (45% m/m), while maintaining the slurry temperature at 60 °C, the leaching time at 30 minutes, and the ultrasound power output at 102 W.

FIG. 16—Illustration of an experimental plot illustrating the effect of the temperature on rare earth element extraction in accordance with an embodiment of the present disclosure. The leaching performance was evaluated at temperatures ranging between at 50 °C and 60 °C using H₂SO₄ (45% m/m), while maintaining the liquid/solid (L/S) ratio at 7, the leaching time at 30 minutes, and the ultrasound power output at 102 W.

FIG. 17—Illustration of an SEM image of: (a) a particulate monazite feed material; (b) the monazite feed material following conventional leaching using H₂SO₄ (40% m/m), a leaching time of 30 minutes, a liquid/solid (L/S) ratio of 7, and temperature at 60 °C; and (c) the monazite feed material following ultrasound assisted leaching using H₂SO₄ (40% m/m), a leaching time of 30 minutes, a liquid/solid (L/S) ratio of 7, a temperature at 60 °C and a ultrasound power output of 102 W.

### DETAILED DESCRIPTION OF ILLUSTRATIVE EMBODIMENTS

Ultrasound advantageously provides for improving the leaching efficiency of rare earth elements. The improved leaching efficiency can in part be attributed to a combination of improved heat and mass transfer, surface activation and impact on the solid-liquid interface. Within heterogeneous systems, such as the leaching of rare earth element containing ore materials, the formation of high velocity microjets resulting from transient cavitation collapse, propagate toward the surface of the ore material leading to pitting and erosion thereby increasing the reactive surface area. Furthermore, transient cavitation results in extreme localized conditions (up to 5000 K and 1000 atm.) resulting in violent collisions and high shear forces. Furthermore, the formation of free radicals during these extreme conditions affect the oxidation potentials of the system. Further advantages to the use of ultrasound in the leaching process of rare earth elements include decreased agglomeration, increased access to a reactive surface by breaking down the particulate feed material (increasing the reactive surface area), improving the diffusion rate, and preventing passivation.

The present disclosure relates to a process for the extraction and recovery of rare earth elements. In an aspect of the present disclosure, the process for the extraction and recovery of rare earth elements comprises an ultrasound assisted extraction step. In a further aspect of the present disclosure, the process for the extraction and recovery of rare earth elements comprises leaching a rare earth element-containing material in an acidic solution while simultaneously sonicating the acidic solution. The present disclosure also relates to a process for the selective extraction/separation of radionuclides from other rare earth elements. These and other aspects of the disclosure are described in greater detail below.

The process for the extraction and recovery of rare earth elements advantageously comprises an ultrasound assisted extraction step providing for the extraction of REE in high yield. In an aspect, the process advantageously provides for the selective separation of rare earth carbonates and oxides based on their respective physical properties. In an aspect, the process advantageously provides for the selective separation of rare earth carbonates produced in the process into light and heavy rare earth carbonates. In an aspect, the process advantageously provides for the oxidation of the rare earth carbonates into the corresponding rare-earth oxides and the selective separation of the rare earth oxides based on their respective physical properties. In an embodiment, the rare earth oxides are advantageously separated using solvent extraction, magnetic separation, or electrostatic separation. In an aspect, the process advantageously provides for the selective extraction/separation of radionuclides, such as thorium and uranium, from other rare earth elements. In an aspect, the process further advantageously provides for the extraction/separation of other elements of value such as tantalum, iridium, tin and lithium, if present in the rare earth element-containing feed material.

In an aspect of the present disclosure, the process substantially comprises only physical separation steps, rather than chemical extraction and purification steps (e.g., use of organic solvents) such as in liquid-liquid hydrometallurgical extraction processes, making the process environmentally cleaner and thus more palatable. In an embodiment, the process comprises an ultrasound-assisted chemical extraction step and one or more physical separation steps. In embodiments of the present disclosure, the rare earth elements may be obtained in the form of chloride salts, sulphate salts, nitrate salts, carbonate salts or as oxides. In a particular embodiment, the rare earth elements are advantageously obtained as oxides.

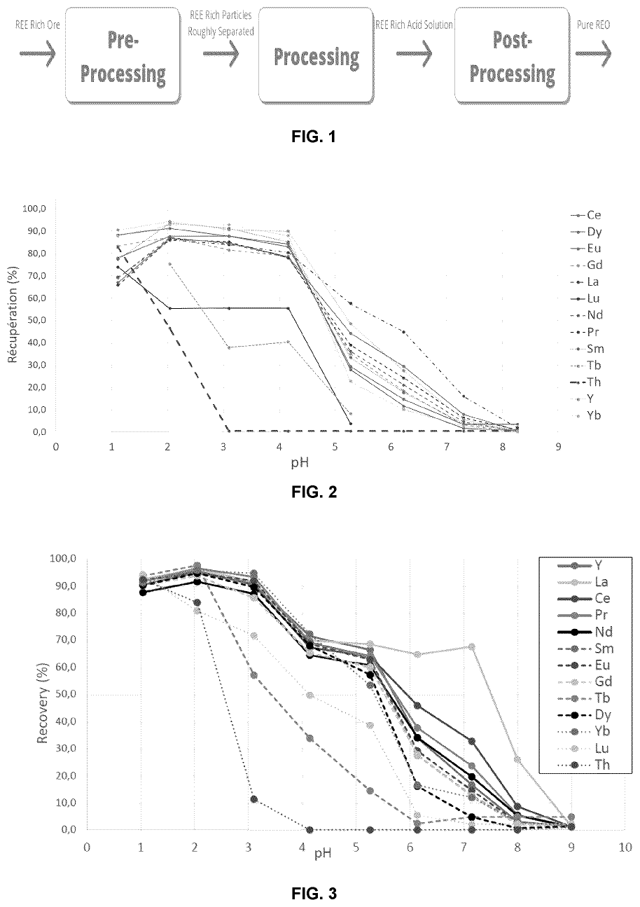

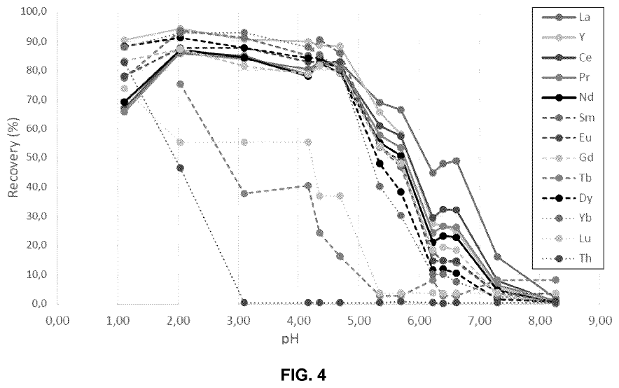

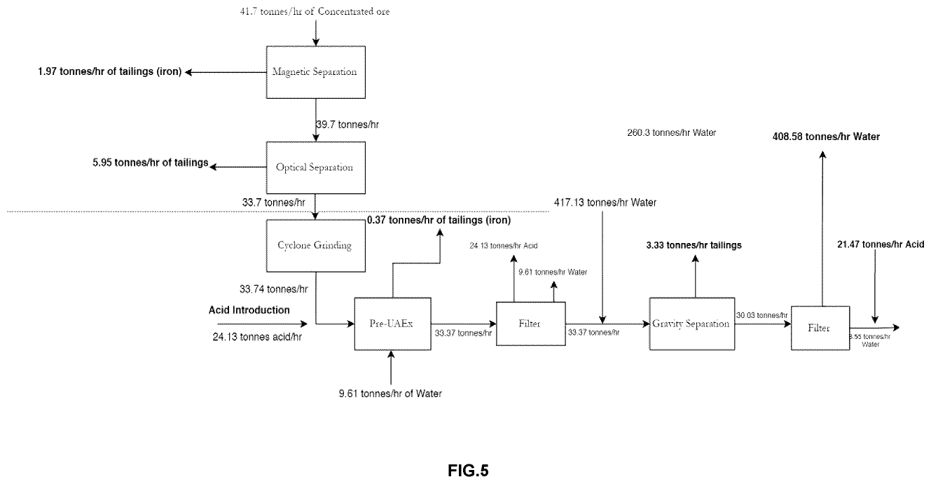

In an embodiment of the present disclosure, and with reference to FIGS. 1-7, the process may be broadly divided into four sections: (1) a first section (“pre-processing”) handling early separation and beneficiation of the rare earth element-containing feed material (e.g., ore material); (2) a second section (“processing”) handling the ultrasound assisted extraction of the rare earth values; (3) a third section (“post-processing”) handling the conversion of the extracted rare earth values into the corresponding carbonates; and (4) a fourth section (“post-processing”) handling the conversion of the rare earth carbonates into the corresponding rare-earth oxides. In the first section, the rare earth element-containing feed material may be subjected to one or more optical and/or magnetic separation techniques, optionally followed by a grinding operation. In the second section, the pH of the pregnant solution, obtained following the ultrasound assisted extraction, may be gradually raised through the slow addition of an alkaline material advantageously providing for the precipitation of gangue material, removal of phosphates, and the precipitation of one or more radionuclide salts (e.g., salts of thorium and/or uranium). In the third section, the extracted rare earth elements may be reacted with a source of carbonate providing a precipitate comprising one or more rare earth carbonates. The carbonates may be subsequently separated into light and heavy rare earth carbonates using centrifugation and/or gravity separation. In the fourth section, the rare earth carbonates may be oxidized (e.g., calcined) into their corresponding rare earth oxides and further separated (e.g., using electrostatic separators). The possibility of effectively and safely removing any radionuclides from the extracted rare earth values advantageous provides for the possibility of the third and fourth sections of the process to be performed at a different site.

With reference to the first section of the process, and with reference to FIG. 5, several separation techniques may be employed for the pre-processing of the rare earth element-containing feed material, non-limiting examples of which include microwave pre-treatment, gravity separation, magnetic separation, froth flotation, and optical separation. Microwave pre-treatment is used to pre-weaken the feed material by triggering the formation of microcracks therein, thereby increasing the surface to volume ratio. Gravity separation takes advantage of the differences in the specific gravities (relative densities) of the components of the feed material. It is of relatively low cost, does not involve any chemicals, and does not have any heating requirements. Gravity separation is advantageously used to remove uranium (i.e., uranium oxide) from the feed material prior to subjecting the feed material to the ultrasound assisted extraction. In an embodiment of the present disclosure, the isolated uranium oxide is advantageously stored in a tank designated for radioactive material storage. Magnetic separation takes advantage of the different behaviors of the components of the feed material when subjected to a magnetic field. Magnetic separation is advantageously used to remove iron (i.e., magnetite; Fe²⁺(Fe³⁺)₂(O²⁻)₄) from the feed material prior to subjecting the feed material to the ultrasound assisted extraction. Froth flotation is a complex, three-phase (solids, water, and air) separation process, that exploits natural and induced differences in the wettability of the components of the feed material. Optical separation takes advantage of the color differences of the components of the feed material. In an embodiment of the present disclosure, gravity, optical and/or magnetic separation are advantageously used in the pre-processing of the rare earth element-containing feed material. In a further embodiment of the present disclosure, pre-processing comprises a grinding step. The grinding step may be advantageously achieved using a ball mill grinder. In a further embodiment of the present disclosure, the feed material is ground to a particle size ranging from about 3 mm to 60 microns. In yet a further embodiment of the present disclosure, the feed material is advantageously ground to a particle size of 60 microns. Grinding of the feed material provides for increasing the surface area of the feed material available for the subsequent ultrasound-assisted extraction step, in turn providing for enhanced leaching rates.

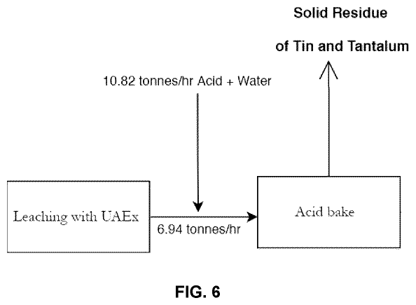

With reference to the second section of the process, and with reference to FIG. 6, the rare earth element-containing feed material is subjected to an ultrasound assisted extraction step, more specifically an acid leaching/sonication step. This step comprises mixing of the feed material with an aqueous acid solution to provide a slurry and subsequently sonicating the slurry while stirring. The sonication advantageously provides for increased leaching rates, shorter extraction times, and reduced acid consumption. Sonication generates cavitation bubbles which aid in breaking up and/or causing the formation of cracks in the feed material which increases the surface area of the feed material resulting in enhanced leaching rates. In an embodiment of the present disclosure, the acid leaching/sonication step is performed as a batch process. Following the ultrasound assisted extraction step, a pregnant solution comprising rare earth element salts is obtained. The rare earth element-containing feed material may also be subjected to an acid induced decomposition step, commonly referred to as an “acid bake”. In the acid bake, the feed material is mixed with an acid (e.g., sulfuric acid) followed by heating the resulting mixture to temperatures ranging between 200-800 °C. In an embodiment of the present disclosure, ultrasound assisted extraction is advantageously used in the processing of a rare earth element-containing feed material. In a further embodiment of the present disclosure, the acid leaching/sonication step may be performed at temperatures ranging between 20 °C and 100 °C. In a further embodiment of the present disclosure, the acid leaching/sonication step may be performed at temperatures ranging between 20 °C and 90 °C.

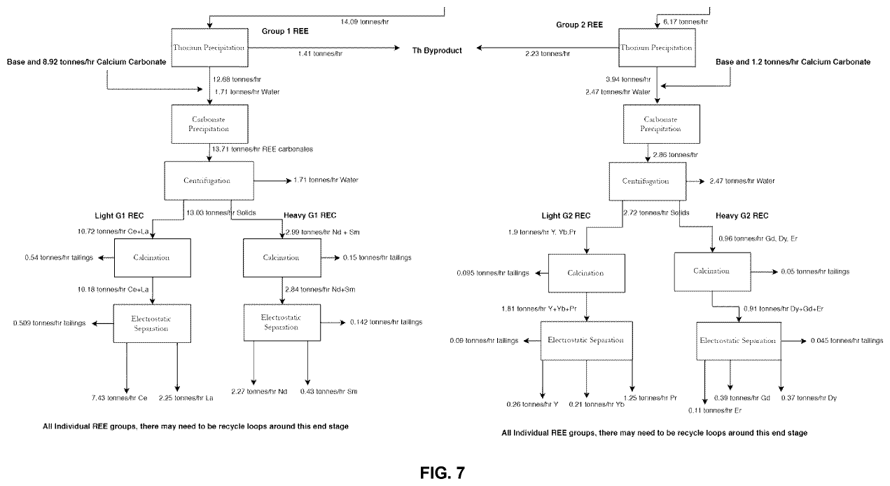

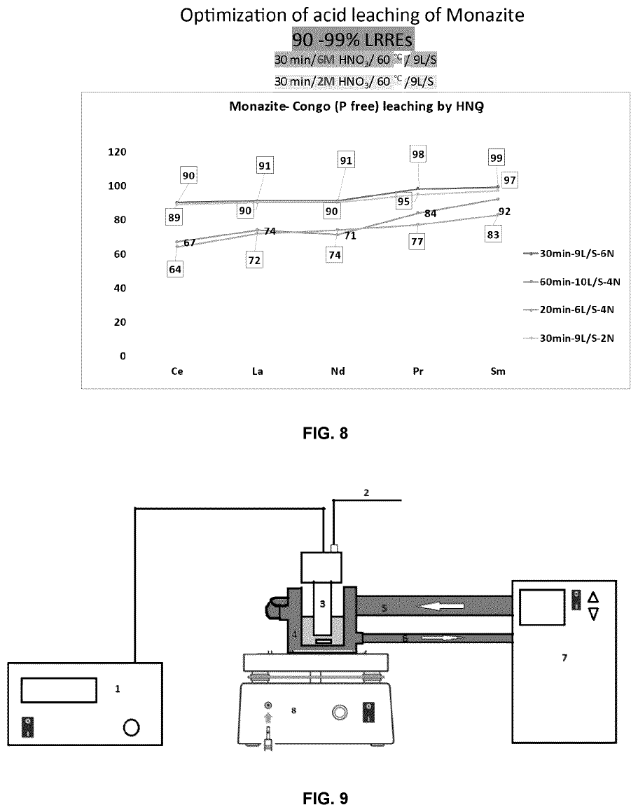

With reference to the third section of the process, and with reference to FIG. 7, the extracted rare earth values are converted into their corresponding carbonates. In this section, the dissolved rare earth values are reacted with a source of carbonate, resulting in the precipitation of the corresponding rare earth carbonates. The reaction with the source of carbonate may be advantageously performed after raising the pH of the rare earth containing solution to about 9. The rare earth carbonates may then be separated into light and heavy rare earth carbonates using centrifugation or gravity separation. In an embodiment of the present disclosure, density gradient centrifugation is advantageously used to separate the light and heavy rare earth carbonates. Various compound densities are illustrated in Table 1.

TABLE 1
Compound Densities for Selected
Rare Earth Carbonates and Oxides.

| Compound | Density [g/cm³] |
|---|---|
| K₂O | 2.35 |
| P₂O₅ | 2.39 |
| CaO | 3.34 |
| MgO | 3.58 |
| Al₂O₃ | 3.95 |
| SrO | 4.70 |
| Y₂(CO₃)₃ | 5.01 |
| BaO | 5.72 |
| Pr₂(CO₃)₃ | 6.50 |
| La₂(CO₃)₃ | 6.51 |
| Gd₂(CO₃)₃ | 7.07 |
| WO₃ | 7.16 |
| Ce₂(CO₃)₃ | 7.22 |
| Nd₂(CO₃)₃ | 7.24 |
| Dy₂(CO₃)₃ | 7.80 |
| Sm₂(CO₃)₃ | 8.35 |
| Er₂(CO₃)₃ | 8.64 |
| Bi₂O₃ | 8.90 |
| Yb₂(CO₃)₃ | 9.17 |
| PbO | 9.53 |
| HfO₂ | 9.68 |

With reference to the fourth section of the process, the rare earth carbonates are oxidized (e.g., calcined) into their corresponding rare earth oxides and further separated. The calcination may be advantageously performed at temperatures ranging between 500 °C and 1200 °C. The oxides are subsequently separated. In an embodiment of the present disclosure, the separation of the rare earth oxides is advantageously performed using electrostatic separators. Electrostatic separation takes advantage of the differences in the conductivity of the rare earth oxides. In a further embodiment of the present disclosure, magnetic separation may be used to separate the rare earth oxides. Solvent extraction may also be used to separate the rare earth oxides.

With reference to the second section of the process and FIGS. 2-4, the gradual and stepwise addition of an alkaline material, such as a base, advantageously provides for the precipitation of unwanted products, such as gangue materials, silicon, iron, and tin, generally referred to as “contaminants”. Further stepwise addition of an alkaline material, such as a base, advantageously provides for the precipitation of any radionuclides such as thorium and/or uranium, typically found in rare earth element-containing feed materials originating from asteroid impact sites. In an embodiment of the present disclosure, thorium precipitation is achieved by raising the pH of the pregnant solution to about 3.0 with little or no precipitation of rare earth elements. Removal of the radionuclides advantageously provides for a non-radioactive solution of rare earth values. Subsequent stepwise addition of an alkaline material, such as a base, advantageously provides for the precipitation of the various rare earth elements. In embodiments of the present disclosure, the alkaline material may be sodium hydroxide (NaOH) and ammonium hydroxide (NH₄OH). Any phosphates present in the pregnant solution are removed prior to the addition of the alkaline material. In an embodiment of the present disclosure, phosphates may be advantageously removed by increasing the pH of the pregnant solution to values not exceeding 3. In yet a further embodiment of the present disclosure, the dissolved rare earth values may be precipitated as oxalates, by raising the pH to a desired pH value and reacting with oxalic acid or sodium oxalate (Table 2).

TABLE 2
Recovery of Rare Earth Elements and Thorium using
Oxalic Acid and Sodium Oxalate precipitation.

| | Oxalic Acid | Sodium Oxalate |
|---|---|---|
| La (%) | 89.41 | 96.19 |
| Y (%) | 91.42 | 96.31 |
| Ce (%) | 94.74 | 98.15 |
| Pr (%) | 96.34 | 98.41 |
| Nd (%) | 97.98 | 99.13 |
| Sm (%) | 99.68 | >99.84 |
| Eu (%) | >96.67 | >96.67 |
| Gd (%) | 99.04 | >99.56 |
| Tb (%) | >76.92 | >76.92 |
| Dy (%) | 96.76 | 98.06 |
| Yb (%) | 93.33 | 96.67 |
| Er (%) | >92.96 | >92.96 |
| Ho (%) | >96.49 | >96.49 |
| Tm (%) | >81.82 | >81.82 |
| Lu (%) | >95.38 | >95.38 |
| Sc (%) | 75.00 | 87.50 |
| Th (%) | >74.36 | >74.36 |

With further reference to the second and third sections of the process and FIGS. 2-4, 6 and 7, the ultrasound assisted extraction step, more specifically the acid leaching/sonication step, may be advantageously conducted at a pH of about 1.3. Following the extraction step, the pH of the pregnant solution is raised by the gradual and stepwise addition of an alkaline material, such as a base. In an embodiment of the present disclosure, the pH of the pregnant solution is gradually increased from about 1.3 to about 3.0 advantageously providing for the selective precipitation of contaminants. The pH of the pregnant solution may then be raised to about 9.0 in order to react the dissolved rare earth values with a source of carbonate, resulting in the precipitation of the corresponding rare earth carbonates. In an embodiment of the present disclosure, the source of carbonate comprises CO₂ gas or a carbonate salt. In a further embodiment of the present disclosure, the carbonate salt may be sodium carbonate (Na₂CO₃), lithium carbonate (Li₂CO₃), and/or calcium carbonate (CaCO₃). In an embodiment of the present disclosure, the formation of the rare-earth carbonates may be advantageously achieved by the injection of carbon dioxide (CO₂) gas into the pregnant solution and/or vessel comprising the pregnant solution. In a further embodiment of the present disclosure, the pH of the pregnant solution is first raised to a pH of about 7 to about 8, and the dissolved rare earth values treated with a source of carbonate. In a subsequent step, the pH is raised to a pH of about 9.0 and further treated with a source of carbonate. The rare earth carbonates may then be separated into light and heavy rare earth carbonates using centrifugation and/or gravity separation.

With further reference to the second section of the process and FIGS. 2-4, and in an embodiment of the present disclosure, the pH of the pregnant solution obtained following the acid leaching/sonication step, may be raised in several (e.g., six) steps. At a pH of about 1.31 the tantalum values precipitate out of the pregnant solution. In embodiments wherein the acid leaching/sonication step and is carried out using sulfuric acid, the tantalum values are obtained as tantalum sulfate. Raising the pH to about 1.52 provides for the precipitation of the niobium values. In embodiments wherein the acid leaching/sonication step and is carried out using sulfuric acid, the niobium values are obtained as niobium sulfate. Further raising the pH to about 1.54 provides for the precipitation of the tin values. In embodiments wherein the acid leaching/sonication step and is carried out using sulfuric acid, the tin values are obtained as tin sulfate. Further raising the pH to about 2.00 provides for the precipitation of the iron and silicon values, and phosphates. In embodiments wherein the acid leaching/sonication step and is carried out using sulfuric acid, the iron and silicon values are obtained as iron and silicon sulfate. Further raising the pH to about 2.73 provides for the precipitation of the titanium values and phosphates. In embodiments wherein the acid leaching/sonication step and is carried out using sulfuric acid, the titanium values are obtained as titanium sulfate. Yet further raising the pH to about 3.00 provides for the precipitation of the thorium values. In embodiments wherein the acid leaching/sonication step and is carried out using sulfuric acid, the thorium values are obtained as thorium sulfate. A small amount of the dissolved rare earth values also precipitates out of the pregnant solution at a pH of about 3.0. In an embodiment of the present disclosure, the thorium sulfate is advantageously stored in a tank designated for radioactive material storage.

With reference to the fourth section of the process, the respective light and heavy rare earth carbonates are oxidized (e.g., calcined) into their corresponding rare earth oxides and further separated. The calcination may be advantageously performed at temperatures ranging between 500 °C and 1200 °C. In an embodiment of the present disclosure, the calcination may be performed at 500 °C. In an embodiment of the present disclosure, the calcination may be performed using a rotary kiln. The light and heavy rare earth oxides are subsequently separated. In an embodiment of the present disclosure, the separation of the light and heavy rare earth oxides is advantageously performed using one or more electrostatic separators. Based on the respective electrical conductivities of the rare earth oxides (Table 3), a desired electrical conductivity is set in order to isolate one or several of the rare earth oxides. In an embodiment of the present disclosure, the isolated light and heavy rare earth oxides are further separated. A first set of electrostatic separators may be designated for the separation of the light rare earth oxides and a second set of electrostatic separators may be designated for the separation of the heavy rare earth oxides. In a further embodiment of the present disclosure, the light rare earth oxides are first separated, followed by the separation of the heavy rare earth oxides.

TABLE 3
Electrical Conductivities for Selected Rare Earth Oxides.

| | Rare Earth | Electrical | Order of |
|---|---|---|---|
| Class | Oxide | Conductivity [s/m] | Precipitation |
| Heavy | Yb₂O₃ | 3.60E+06 | 1 |
| Heavy | Nd₂O₃ | 1.60E+06 | 2 |
| Heavy | Sm₂O₃ | 1.10E+06 | 4 |
| Heavy | Dy₂O₃ | 1.10E+06 | 5 |
| Heavy | Er₂O₃ | 1.20E+06 | 3 |
| Light | Y₂O₃ | 1.80E+06 | 2 |
| Light | La₂O₃ | 1.60E+06 | 3 |
| Light | CeO2 | 1.40E+06 | 4 |
| Light | Pr₆O₁₁ | 1.40E+06 | 5 |
| Light | Gd₂O₃ | 7.70E+06 | 1 |

In an embodiment of the present disclosure, the rare earth element-containing feed material may be monazite. In further embodiments of the present disclosure, the rare earth element-containing feed material may be cheralite, huttonite, xenotime, coesite, and/or gadolinium neodymium dizirconate. The monazite feed material comprises at least several of the following oxides: Al₂O₃, BaO, Bi₂O₃, CaO, CeO₂, Dy₂O₃, Er₂O₃, Fe₂O₃, Gd₂O₃, HfO₂, K₂O, La₂O₃, MgO, Nb₂O₅, Nd₂O₃, P₂O₅, PbO, Pr₆O₁₁, SiO₂, Sm₂O₃, SnO₂, SrO, Ta₂O₅, ThO₂, TiO₂, UO₂, H₂O, WO₃, Y₂O₃ and Yb₂O₃.

In an embodiment of the present disclosure, the acid leaching/sonication step is performed using sulfuric acid, converting the oxides of the monazite feed material into the corresponding sulfates.

In embodiments of the present disclosure, the leaching solution comprises from about 5 wt. % to about 100 wt. % H₂SO₄; in a further embodiment from about 5 wt. % to about 90 wt. % H₂SO₄; in a further embodiment from about 10 wt. % to about 80 wt. % H₂SO₄; in a further embodiment from about 15 wt. % to about 70 wt. % H₂SO₄; in a further embodiment from about 20 wt. % to about 60 wt. % H₂SO₄; in a further embodiment from about 30 wt. % to about 50 wt. % H₂SO₄; about 5 wt. % H₂SO₄; about 10 wt. % H₂SO₄; about 15 wt. % H₂SO₄; about 20 wt. % H₂SO₄; about 25 wt. % H₂SO₄; about 30 wt. % H₂SO₄; about 35 wt. % H₂SO₄; about 40 wt. % H₂SO₄; about 45 wt. % H₂SO₄; about 50 wt. % H₂SO₄; about 55 wt. % H₂SO₄; about 60 wt. % H₂SO₄; about 65 wt. % H₂SO₄; about 70 wt. % H₂SO₄; about 75 wt. % H₂SO₄; about 80 wt. % H₂SO₄; about 85 wt. % H₂SO₄; about 90 wt. % H₂SO₄; about 95 wt. % H₂SO₄; or about 100 wt. % H₂SO₄.

In an embodiment of the present disclosure, the acid leaching/sonication step is performed using nitric acid (HNO₃), converting the oxides of the monazite feed material into the corresponding nitrates. In this particular example, the nitric acid leaching/sonication was performed using a nitric acid concentration ranging between about 2M and about 6M, at a temperature ranging between about 50 °C and about 60 °C, over a time ranging from about 30 minutes to about 60 minutes, and at an amplitude of about 80% (Table 4).

In embodiments of the present disclosure, the leaching solution comprises from about 5 wt. % to about 100 wt. % HNO₃; in a further embodiment from about 5 wt. % to about 90 wt. % HNO₃; in a further embodiment from about 10 wt. % to about 80 wt. % HNO₃; in a further embodiment from about 15 wt. % to about 70 wt. % HNO₃; in a further embodiment from about 20 wt. % to about 60 wt. % HNO₃; in a further embodiment from about 30 wt. % to about 50 wt. % HNO₃; about 5 wt. % HNO₃; about 10 wt. % HNO₃; about 15 wt. % HNO₃; about 20 wt. % HNO₃; about 25 wt. % HNO₃; about 30 wt. % HNO₃; about 35 wt. % HNO₃; about 40 wt. % HNO₃; about 45 wt. % HNO₃; about 50 wt. % HNO₃; about 55 wt. % HNO₃; about 60 wt. % HNO₃; about 65 wt. % HNO₃; about 70 wt. % HNO₃; about 75 wt. % HNO₃; about 80 wt. % HNO₃; about 85 wt. % HNO₃; about 90 wt. % HNO₃; about 95 wt. % HNO₃; or about 100 wt. % HNO₃.

TABLE 4
Recovery of Selected Rare Earth Elements from Congo Monazite
Feed Material Following Nitric Acid Leaching/Sonication.

| | | | Amplitude | Temp. | Time | Ce | La | Nd | Pr | Sm |
|---|---|---|---|---|---|---|---|---|---|---|
| Run | HNO₃ | SL ratio | (%) | (°C) | (min) | (%) | (%) | (%) | (%) | (%) |
| 1 | 6M | 9 | 80 | 50-60 | 30 | 89.41 | 90.79 | 90.55 | 97.39 | 98.79 |
| 2 | 2M | 9 | 80 | 50-60 | 30 | 88.92 | 89.98 | 90.43 | 94.54 | 97.27 |

In an embodiment of the present disclosure, the ultrasound-assisted extraction may be advantageously performed at the natural frequency of the rare earth element-containing feed material. In further embodiments of the present disclosure, the sonication is performed at a frequency ranging from about 20 to about 200 kHz, from about 30 to about 200 kHz; from about 40 to about 200 kHz; from about 50 to about 200 kHz, from about 60 to about 200 kHz; from about 70 to about 200 kHz; from about 80 to about 200 kHz, from about 90 to about 200 kHz; from about 100 to about 200 kHz; from about 110 to about 200 kHz, from about 120 to about 200 kHz; from about 130 to about 200 kHz; from about 140 to about 200 kHz; from about 150 to about 200 kHz, from about 160 to about 200 kHz; from about 170 to about 200 kHz; from about 180 to about 200 kHz; about 20 kHz; about 30 kHz; about 40 kHz; about 50 KHz; about 60 KHz; about 70 kHz; about 80 kHz; about 90 kHz; about 100 kHz; about 110 kHz; about 120 kHz; about 130, about 140 kHz; about 150 kHz; about 160 kHz; about 170 kHz; about 180, about 190 kHz; or about 200 kHz.

In an embodiment of the present disclosure, the ultrasound-assisted extraction may be advantageously performed at an amplitude ranging from about 1% to about 100%; from about 5% to about 100%; from about 10% to about 100%; from about 15% to about 100%; from about 20% to about 100%; from about 25% to about 100%; from about 25% to about 100%; from about 30% to about 100%; from about 35% to about 100%; from about 40% to about 100%; from about 45% to about 100%; from about 50% to about 100%; from about 55% to about 100%; from about 60% to about 100%; from about 65% to about 100%; from 70% to about 100%; from about 75% to about 100%; from about 80% to about 100%; from about 85% to about 100%; from about 90% to about 100%; about 5%; about 10%; about 15%; about 20%; about 25%; about 30%; about 35%; about 40%; about 45%; about 50%; about 55%; about 60%; about 65%; about 70%; about 75%; about 80%; about 85%; about 90%; about 95%; or about 100%.

In an embodiment of the present disclosure, the ultrasound-assisted extraction may be advantageously performed at an ultrasound power output ranging from about 50 W to about 150 W; from about 50 W to about 145 W; from about 55 W to about 140 W; from about 60 W to about 135 W; from about 65 W to about 130 W; from about 70 W to about 125 W; from about 70 W to about 120 W; about 78 W to about 116 W; about 50 W; about 55 W; about 60 W; about 65 W; about 75 W; about 80 W; about 85 W; about 90 W; about 94 W; about 95 W; about 100 W; about 102 W; about 105 W; about 110 W; about 115 W; or about 120 W.

In an embodiment of the present disclosure, the rare earth element-containing feed material is ground to a particle size ranging from about 3 mm to 60 microns; from about 2 mm to 60 microns; from about 1 mm to 60 microns; from about 0.5 mm to 60 microns; to a particle size less than 3 mm; to a particle size less than 2 mm; to a particle size less than 1 mm; to a particle size less than 0.5 mm; to a particle size less than 0.1 mm; to a particle size less than 0.05 mm; to a particle size less than 0.01 mm; to a particle size of about 100 microns; to a particle size of about 90 microns; to a particle size of about 80 microns; to a particle size of about 70 microns; or to a particle size of about 60 microns.

In an embodiment of the present disclosure, the rare earth element-containing feed material is a monazite feed material obtained from Vichada, Colombia. The feed material comprises a total rare earth content in excess of 61% (Table 5).

TABLE 5
Rare earth content of Vichada monazite feed material.

| | | Sample # | Sample # | Sample # | Sample # |
|---|---|---|---|---|---|
| Rare Earth | | (S00357795) | (S00357796) | (S00357793A) | (S00357795B) |
| Element | Symbol | Grade (%) | Grade (%) | Grade (%) | Grade (%) |
| Cerium | CeO₂ | 36.75 | 38.82 | 43.93 | 40.74 |
| Neodymium | Nd₂O₃ | 7.38 | 8.39 | 8.44 | 7.84 |
| Lanthanum | La₂O₃ | 9.37 | 6.80 | 7.77 | 8.56 |
| Praseodymium | Pr₆O₁₁ | 1.82 | 2.74 | 2.25 | 2.13 |
| Samarium | Sm₂O₃ | 2.08 | 2.59 | 2.37 | 2.12 |
| Gadolinium | Gd₂O₃ | 2.17 | 2.39 | 2.67 | 2.46 |
| Dysprosium | Dy₂O₃ | 0.70 | 0.96 | 0.49 | 0.91 |
| Yttrium | Y₂O₃ | 0.12 | 1.03 | 0.07 | 0.10 |
| Ytterbium | Yb₂O₃ | 0.38 | 0.40 | 0.22 | 0.61 |
| Erbium | Er₂O₃ | 0.25 | 0.09 | 0.11 | 0.20 |

| | | | | |
|---|---|---|---|---|
| Total Rare Earth Oxide | 61.02 | 64.21 | 68.32 | 65.67 |
| Content | | | | |

In addition to the rare earth values illustrated in Table 5, the Vichada monazite feed material may further comprise titanium (TiO₂), iron (Fe₂O₃), zirconium (ZrO₂), niobium (Nb₂O₅) and hafnium (HfO₂) values. Titanium readily combines with iron, aluminum, vanadium, nickel, molybdenum, and other metals to produce high-performance alloys useful for the manufacture of jet engines, spacecraft, and various military equipment. Titanium has been listed on the list of 35 minerals critical to U.S. national security.

In an embodiment of the present disclosure, the rare earth element-containing feed material is a monazite feed material obtained from the Democratic Republic of the Congo (DRC). The composition of the feed material is illustrated in Table 6. X-ray fluorescence (XRF) was used to determine the amounts of the elements present in the samples. The samples were previously subjected to a grinding operation (D₈₀ of 170 mesh).

TABLE 6
Rare earth content of DRC feed material.

Weight percentage (%)

| Element | Sample 1 | Sample 2 |
|---|---|---|
| Ce | 24.218 | 26.656 |
| P | 6.125 | 5.756 |
| Nd | 13.425 | 14.860 |
| Si | 3.429 | 3.292 |
| La | 8.282 | 9.505 |
| Sn | 12.451 | 4.321 |
| Al | 1.8 | 0.976 |
| Pr | 2.121 | 2.654 |
| Fe | 5.08 | 2.757 |
| Sm | 1.39 | 1.702 |
| Gd | 0 | 0 |
| Th | 0.546 | 0.866 |
| Y | 0.471 | 0.565 |
| K | 0.092 | 0.286 |
| Ca | 0.607 | 0.657 |
| Nb | 0.074 | 0.091 |
| Sr | 0.154 | 0.214 |
| Zr | 0.183 | 0.157 |
| S | 0.044 | 0.159 |
| Dy | 0 | 0 |
| Pb | 0.041 | 0.054 |
| Cl | 0.151 | 0.149 |
| Ta | 0.093 | 0.136 |
| U | 0.05 | 0.066 |
| Ni | 0 | 0.052 |

The reagents used for the leaching of the DRC samples were analytical grade H₂SO₄ (50% m/v and 98% m/m), HNO₃ (70% w/w), and HCl (37% w/w), all obtained from Fischer™ and diluted using deionized water. Ultrasound for the leaching process was provided using a probe type Synetude M440 ultrasonic processor with a frequency of 20 KHz and a variable power input. A Monel® alloy probe having a 40 mm diameter and a maximum amplitude of 8 μm, was used for the generation of the ultrasonic waves. The sonication causes large increases in solution temperature which were controlled to within ±2 °C using a Fischer Scientific Thermostatic ISOTEMP thermostatic water bath and a 250 mL jacketed beaker. A homogenous slurry was maintained using a magnetic stirrer at a constant rate of 450 RPM (optically determined to be sufficient). The temperatures in the jacketed reactor were measured using a thermocouple. The experimental sono-chemical leaching setup is illustrated in FIG. 9. Filtration was conducted using a vacuum filter, while drying was performed in an oven.

The calorimetric method was used to calculate the power dissipation of the ultrasound system at amplitudes of 50%, 60%, 70%, 80% and 90%.

$${P}_{d i s s} = m C p ( \frac{d T}{d t} )$$

Cₚ is the specific heat of the medium; m is the mass of the liquid being sonicated; and (dT/dt) is the measurement of temperature over time. Calibration is conducted using 500 mL of water. The calibration values are illustrated in Table 7.

TABLE 7
Calibration values.

| Amplitude | 50% | 60% | 70% | 80% | 90% |
|---|---|---|---|---|---|
| Power dissipated (W) | 71 | 78 | 94 | 103 | 116 |

For the leaching, using monazite sample sizes ranging from 8-15 g, the probe was positioned 3 cm from the bottom of the reactor to ensure reproducibility and ensure homogenous mixing, without interfering with the magnetic stirrer. Initial tests having demonstrated that the probe position plays a role in the extraction efficiency, this position was determined to be optimal, even though not required. The probe was started until the desired temperature was reached at which point the monazite sample was added and the timer started. Following the ultrasound assisted extraction, the slurry was filtered, washed, and dried at 90 °C for 24 hours. The dried residue was then weighed and subjected to XRF analysis. All experiments conducted were batchwise and performed under atmospheric pressure.

$$yield = ( \frac{{m}_{x , i n i t i a l} {c}_{x , initial} - {m}_{x , residue} {c}_{x , residue}}{{m}_{x , initial} {c}_{x , initial}} ) * 100$$

x represents the element in question (element analyzed); mᵢₙᵢₜᵢₐₗ and m_{residue} represent the masses of the initial sample and residue respectively; and cᵢₙᵢₜᵢₐₗ and c_{residue} are the initial and final concentrations obtained from the XRF analysis. Due to their abundance in the sample, cerium, neodymium and lanthanum were chosen to display the REE leaching efficiencies and were reflective of the other REEs.

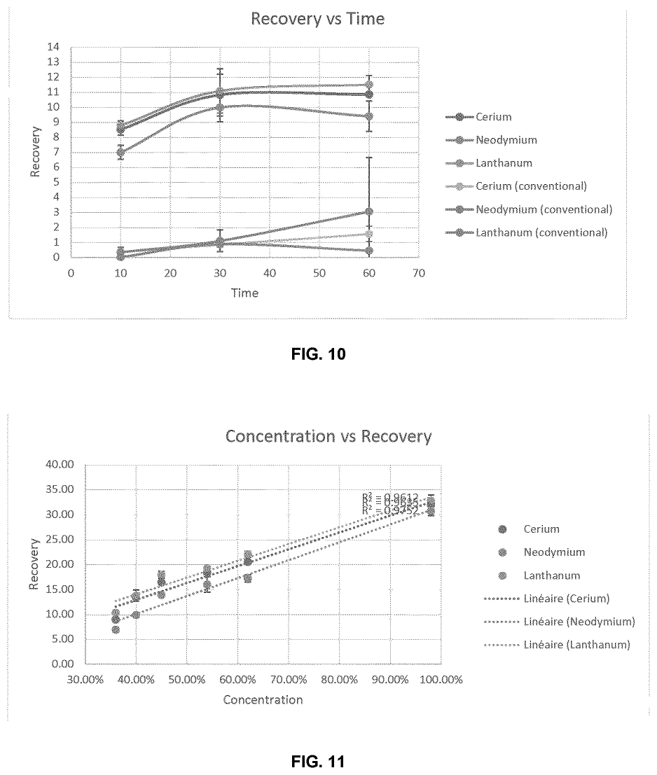

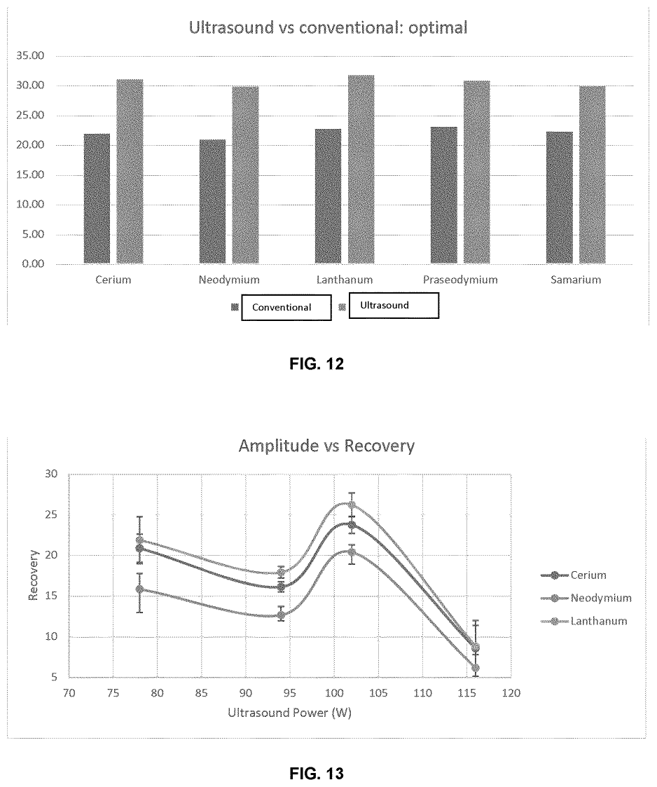

In an aspect, various sulfuric acid leaching times were investigated. The leaching performance was evaluated at 10, 30 and 60 minutes respectively, using H₂SO₄ (40% m/m), a slurry temperature of 60 °C, a liquid/solid (L/S) ratio of 7, and an ultrasound power output of 94 W. The leaching performance was also evaluated at 10, 30 and 60 minutes respectively, using H₂SO₄ (40% w/w), a slurry temperature of 60 °C, a liquid/solid (L/S) ratio of 7, but without the assistance of ultrasound. The results are illustrated in FIG. 10. The impact of ultrasound assistant leaching relative to leaching without ultrasound is immediately visible, showing an immediate jump in leaching efficiency within just 10 minutes. The use of ultrasound provides for recoveries of 8.49%, 6.97% and 8.76% for cerium, neodymium and lanthanum respectively, indicating a rapid breakdown of the monazite material. Ultrasound, in addition to potentially amorphizing the crystal structure of the particulate monazite feed material, rapidly increases the reactive surface area by rapidly breaking down the monazite particulate material due to surface cavitation effects (FIG. 17), thus increasing leaching efficiency at the particle surface where cavitation effects can directly act. The slow increase in recovery between 10-30 minutes may be indicative of the onset of a different extraction mechanism which could be associated with the reaction kinetics being substantially dominated by the acid breaking down the internal structure of the monazite particles, and enhancing the reaction due to the normal shrinking of the core of the monazite particles. The extraction appears to plateau at 30 minutes, which could indicate an optimum value for the system. Moreover, solubility constraints for the obtained rare earth sulphates may also be noted as a contributing factor.

In an aspect, various sulfuric acid concentrations were investigated. The H₂SO₄ concentration was varied between 36% and 98% (m/m) while maintaining the slurry temperature at 60 °C, the liquid/solid (L/S) ratio at 7, the leaching time at 30 minutes, and the ultrasound power output at 94 W. Lower acid concentrations advantageously provide for a more cost effective and environmentally friendly process, reduces equipment corrosion, and extends the lifetime of the sonotrode by reducing erosion during the leaching process. The optimal H₂SO₄ concentration was also evaluated without the assistance of ultrasound. The results are illustrated in FIG. 11. Increasing the acid concentration improves the leaching efficiency, which may be attributed, at least in part, due to increased interaction between the monazite material and the acid.

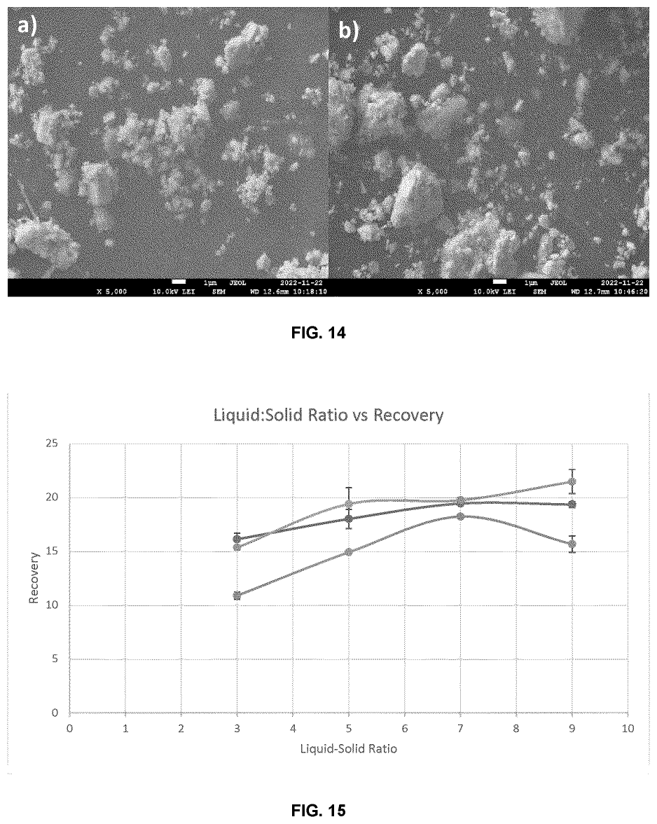

In an aspect, various ultrasound power outputs were investigated. In an aspect of the present disclosure, the power output ranges between 50 W and 16 000 W. The power output is determined, at least in part, based on the volume to be treated. Smaller volumes require less power. In a further aspect of the present disclosure, the sonication is performed between 200 W/L and 2000 W/L. In a particular embodiment of the present disclosure, the leaching performance was evaluated at ultrasound power outputs ranging between 78 W and 116 W using H₂SO₄ (40% m/m), while maintaining the slurry temperature at 60 °C, the liquid/solid (L/S) ratio at 7, and the leaching time at 30 minutes. The results are illustrated in FIG. 13. It is interesting to note that the leaching performance varies only slightly from 78-102 W. However, there appears to be an optimal power output at 102 W. Increasing the power output results in an increase of both the number and size of the cavitation bubbles, which increases the cavitation effects during the leaching process. The increased cavitation effects advantageously enhance the leaching efficiency. The decrease in leaching efficiency at power outputs in excess of 110 W may be attributed to the formation of bubble clouds which coalesce at higher powers resulting in shielding effects. Moreover, increasing the number of cavitation bubbles adversely affects the energy transfer from the ultrasound. With reference to FIG. 14, the particles resulting from sonication at a power setting of 102 W are both smaller and more porous relative to particles resulting from sonication at a power setting of 116 W.

In an aspect, various liquid/solid (L/S) ratios were investigated. The leaching performance was evaluated using L/S ratios ranging from 3:1 to 9:1 using H₂SO₄ (45% m/m), while maintaining the slurry temperature at 60 °C, the leaching time at 30 minutes, and the ultrasound power output at 102 W. The optimal liquid/solid (L/S) ratios were also evaluated without the assistance of ultrasound. The results are illustrated in FIG. 15. Increasing the liquid/solid (L/S) ratio generally results in improved recoveries of the studied rare-earths elements. This may be attributed to the increased availability of the leachant (H₂SO₄ (45% m/m)) and less diffusion resistance for surface contact with the particulate monazite feed material. Moreover, cavitation becomes more difficult under lower liquid/solid (L/S) ratios.

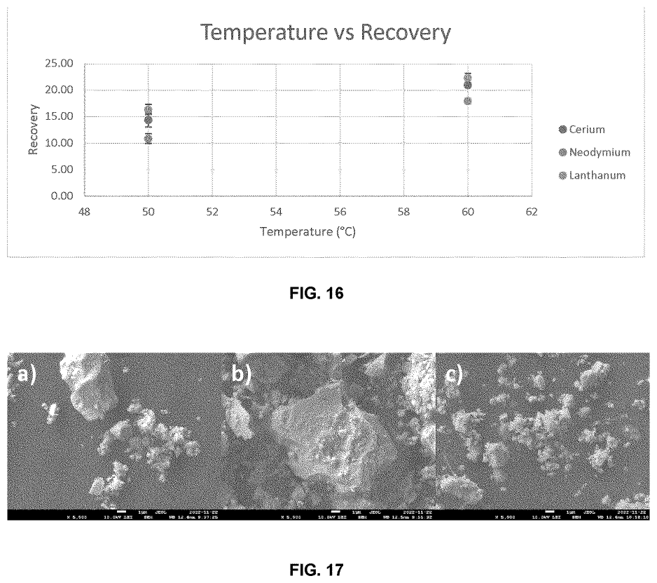

In an aspect, various sulfuric acid leaching temperatures were investigated. The leaching performance was evaluated at temperatures ranging between at 50 °C and 60 °C using H₂SO₄ (45% m/m), while maintaining the liquid/solid (L/S) ratio at 7, the leaching time at 30 minutes, and the ultrasound power output at 102 W. The optimal temperature conditions were also evaluated without the assistance of ultrasound. The results are illustrated in FIG. 16. Increasing the leaching temperature provides for improved recoveries of the studied rare-earths elements. Higher temperatures provide the system with more energy, resulting in increases of the reactive surface area by enhancing the breakdown of the particulate monazite feed material.

The effects of ultrasound assisted leaching are illustrated in FIG. 17. Ultrasound assisted leaching results in a material comprising comparatively smaller particles displaying heavy pitting, indicative of cavitation (microjet) breakdown. Leaching without ultrasound is characterized by a slow and gradual breakdown of the particulate monazite feed material and rather slow reaction kinetics. The particles are both larger and smoother relative to those observed for ultrasound assisted leaching. Recoveries of 1.5%, 0.85% and 3.02% were observed for cerium, neodymium and lanthanum respectively (FIG. 10; bottom section). As illustrated by the results depicted in Table 8, the improvements due to sonication are more dramatic at lower acid concentrations. Leaching at higher acid concentrations provides for more breakdown of the particulate monazite feed material rendering the sonication effects, even though observed, less pronounced. Moreover, the cavitation effects imparted by the sonication may be less pronounced at higher acid concentrations, likely due to higher solution viscosities.

TABLE 8
Leaching Improvements (%) Imparted by Sonication
as a Function of Acid Concentration.

| | Percentage improvement between conventional and | |
|---|---|---|
| | sonication-assisted leaching | |
| | H₂SO₄ (40% m/m) | H₂SO₄ (98% m/m) |
| Cerium | 604 | 42 |
| Neodymium | 1070 | 43 |
| Lanthanum | 924 | 40 |
| Praseodymium | 829 | 34 |
| Samarium | 760 | 34 |

While the present disclosure has been described with reference to specific examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

1. A process for extracting one or more rare earth elements from a rare earth element-containing material, the process comprising:
leaching the rare earth element-containing material in an acidic solution while simultaneously sonicating the acidic solution thereby producing a pregnant solution;
raising the pH of the pregnant solution to about 3 providing for the precipitation of a radionuclide salt from the pregnant solution and producing a substantially radionuclide depleted pregnant solution;
raising the pH of the substantially radionuclide depleted pregnant solution to about 9 and treating the solution with a source of carbonate to provide a precipitate comprising one or more rare earth carbonates;
oxidizing the one or more rare earth carbonates producing one or more rare earth oxides; and
selectively separating the one or more rare earth oxides.

2. The process of claim 1, wherein the sonication is performed at a frequency ranging from about 20 to about 200 kHz and an amplitude ranging from 1% to 100%.

3. The process of claim 1 or 2, wherein the leaching is performed at temperatures ranging between about 20 °C and about 200 °C.

4. The process of any one of claims 1 to 3, wherein the radionuclide is at least one of thorium or uranium.

5. The process of any one of claims 1 to 4, further comprising subjecting the rare earth element-containing material to at least one beneficiation step prior to the leaching to remove any gangue material.

6. The process of claim 5, wherein the at least one beneficiation step comprises separation based on optical and magnetic properties, sensor-based sorting, flotation, gravity separation, and comminuting, crushing or grinding.

7. The process of any one of claims 1 to 6, further comprising separating the rare earth carbonates into light and heavy rare earth carbonates.

8. The process of claim 7, wherein the light rare earth carbonates comprise Y₂(CO₃)₃, La₂(CO₃)₃, Ce₂(CO₃)₃, Pr₂(CO₃)₃, and hydrates thereof.

9. The process of claim 7, wherein the heavy rare earth carbonates comprise Yb₂(CO₃)₃, Nd₂(CO₃)₃, Sm₂(CO₃)₃, Dy₂(CO₃)₃, Gd₂(CO₃)₃, and Er₂(CO₃)₃, and hydrates thereof.

10. The process of any one of claims 7 to 9, wherein the separating is performed by centrifugation.

11. The process of any one of claims 1 to 10, wherein the source of carbonate comprises CO₂ gas or a carbonate salt.

12. The process of claim 11, wherein the carbonate salt is one or more of sodium carbonate (Na₂CO₃), lithium carbonate (Li₂CO₃), or calcium carbonate (CaCO₃).

13. The process of any one of claims 1 to 12, wherein the oxidizing of the rare earth carbonates comprises calcination of the rare earth carbonates.

14. The process of claim 13, wherein the calcination is performed at temperatures between about 500 °C and about 1200 °C.

15. The process of any one of claims 1 to 14, wherein the selectively separating the rare earth oxides is performed by at least one of solvent extraction, magnetic separation, or electrostatic separation.

16. The process of any one of claims 1 to 15, wherein the rare earth element-containing material comprises rare-earth element bearing ore materials, mine tailings, waste coal ash, or industrial waste materials.

17. The process of any one of claims 1 to 16, wherein the acidic solution is at least one of a sulfuric acid solution, a hydrochloric acid solution, a nitric acid solution, a carbonic acid solution, or a combination of any thereof.

18. The process of any one of claims 1 to 17, wherein the radionuclide salt is at least one of thorium sulfate, uranium sulfate, thorium chloride, uranium chloride, thorium nitrate, uranium nitrate, and hydrates thereof.

19. The process of any one of claims 1 to 18, further comprising removing phosphates from the pregnant solution.

20. The process of claim 19, wherein phosphate removal is performed by raising the pH of the pregnant solution to not greater than 3 to avoid precipitation of the radionuclide salt from the pregnant solution.

21. The process of claim 5, wherein the gangue material comprises at least one of iron, silicon, tin, phosphate or tantalum.

22. The process of any one of claims 1 to 21, wherein the sonication is performed using an external sonication probe.

23. The process of any one of claims 1 to 21, wherein the sonication is performed using an internal sonication probe.

24. A process for separating thorium from an acidic solution comprising thorium and at least one or more rare earth elements, the process comprising:
raising the pH of the acidic solution to about 3 providing for the precipitation of a thorium salt from the acidic solution, and producing a substantially thorium depleted acidic solution;
wherein the acidic solution is obtained by leaching a rare earth element-containing material while simultaneously sonicating the acidic solution, thereby producing the acidic solution.

25. The process of claim 24, further comprising:
raising the pH of the substantially thorium depleted pregnant solution to about 9 and treating the solution with a source of carbonate to provide a precipitate comprising one or more rare earth carbonates;
oxidizing the one or more rare earth carbonates producing one or more rare earth oxides; and
selectively separating the one or more rare earth oxides.

26. The process of claim 24 or 25, wherein the sonication is performed at a frequency ranging from about 20 to about 200 kHz and an amplitude ranging from 1% to 100%.

27. The process of any one of claims 24 to 26, wherein the leaching is performed at temperatures ranging between about 20 °C and about 200 °C.

28. The process of any one of claims 24 to 27, further comprising subjecting the rare earth element-containing material to at least one beneficiation step prior to the leaching to remove any gangue material.

29. The process of claim 28, wherein the at least one beneficiation step comprises separation based on optical and magnetic properties, sensor-based sorting, flotation, gravity separation, and comminuting, crushing or grinding

30. The process of claim 25, further comprising separating the rare earth carbonates into light and heavy rare earth carbonates.

31. The process of claim 30, wherein the light rare earth carbonates comprise Y₂(CO₃)₃, La₂(CO₃)₃, Ce₂(CO₃)₃, Pr₂(CO₃)₃, and hydrates thereof.

32. The process of claim 30, wherein the heavy rare earth carbonates comprise Yb₂(CO₃)₃, Nd₂(CO₃)₃, Sm₂(CO₃)₃, Dy₂(CO₃)₃, Gd₂(CO₃)₃, Er₂(CO₃)₃ and hydrates thereof.

33. The process of any one of claims 30 to 32, wherein the separating is performed by centrifugation.

34. The process of claim 25, wherein the source of carbonate comprises CO₂ gas or a carbonate salt.

35. The process of claim 34, wherein the carbonate salt is one or more of sodium carbonate (Na₂CO₃), lithium carbonate (Li₂CO₃), or calcium carbonate (CaCO₃).

36. The process of claim 25, wherein the oxidizing of the rare earth carbonates comprises calcination of the rare earth carbonates.

37. The process of claim 36, wherein the calcination is performed at temperatures between about 500 °C and about 1200 °C.

38. The process of claim 25, wherein the selectively separating the rare earth oxides is performed by at least one of solvent extraction, magnetic separation, or electrostatic separation.

39. The process of any one of claims 24 to 38, wherein the rare earth element-containing material comprises rare-earth element bearing ore materials, mine tailings, waste coal ash, or industrial waste materials.

40. The process of any one of claims 24 to 39, wherein the acidic solution is at least one of a sulfuric acid solution, a hydrochloric acid solution, a nitric acid solution, a carbonic acid solution, or a combination of any thereof.

41. The process of any one of claims 24 to 40, wherein the thorium salt is at least one of thorium sulfate, thorium chloride, thorium nitrate, or hydrates thereof.

42. The process of claim 25, further comprising removing phosphates from the acidic solution.

43. The process of claim 42, wherein phosphate removal is performed by raising the pH of the acidic solution to not greater than 3 to avoid precipitation of the thorium salt from the acidic solution.

44. The process of claim 28, wherein the gangue material comprises at least one of iron, silicon, tin, phosphate or tantalum.

45. The process of any one of claims 24 to 44, wherein raising the pH of the acidic solution to about 3 further provides for the precipitation of a uranium salt from the acidic solution.

46. The process of claim 45, wherein the uranium salt is at least one of uranium sulfate, uranium chloride, uranium nitrate, or hydrates thereof.

47. The process of any one of claims 24 to 46, wherein the sonication is performed using an external sonication probe.

48. The process of any one of claims 24 to 46, wherein the sonication is performed using an internal sonication probe.

49. A process for extracting one or more rare earth elements from an acidic solution, the process comprising:
raising the pH of the acidic solution to about 3 providing for the precipitation of a radionuclide salt from the acidic solution, and producing a substantially radionuclide depleted acidic solution;
wherein the acidic solution is obtained by leaching a rare earth element-containing material in an acidic acid solution while simultaneously sonicating the acidic solution thereby producing the acidic solution.

50. The process of claim 49, further comprising:
raising the pH of the substantially radionuclide depleted pregnant solution to about 9 and treating the solution with a source of carbonate to provide a precipitate comprising one or more rare earth carbonates;
oxidizing the one or more rare earth carbonates producing one or more rare earth oxides; and
selectively separating the one or more rare earth oxides.

51. The process of claim 49 or 50, wherein the sonication is performed at a frequency ranging from about 20 to about 200 kHz and an amplitude ranging from 1% to 100%.

52. The process of any one of claims 49 to 51, wherein the leaching is performed at temperatures between about 20 °C and about 200 °C.

53. The process of any one of claims 49 to 52, wherein the radionuclide is at least one of thorium or uranium.

54. The process of any one of claims 49 to 53, further comprising subjecting the rare earth element-containing material to at least one beneficiation step prior to the leaching to remove any gangue material.

55. The process of claim 54, wherein the at least one beneficiation step comprises separation based on optical and magnetic properties, sensor-based sorting, flotation, gravity separation, and comminuting, crushing or grinding.

56. The process of claim 50, further comprising separating the rare earth carbonates into light and heavy rare earth carbonates.

57. The process of claim 56, wherein the light rare earth carbonates comprise Y₂(CO₃)₃, La₂(CO₃)₃, Ce₂(CO₃)₃, Pr₂(CO₃)₃, and hydrates thereof.

58. The process of claim 57, wherein the heavy rare earth carbonates comprise Yb₂(CO₃)₃, Nd₂(CO₃)₃, Sm₂(CO₃)₃, Dy₂(CO₃)₃, Gd₂(CO₃)₃, Er₂(CO₃)₃, and hydrates thereof.

59. The process of any one of claims 56 to 58, wherein the separating is performed by centrifugation.

60. The process of claim 50, wherein the source of carbonate comprises CO₂ gas or a carbonate salt.

61. The process of claim 60, wherein the carbonate salt is one or more of sodium carbonate (Na₂CO₃), lithium carbonate (Li₂CO₃), or calcium carbonate (CaCO₃).

62. The process of claim 50, wherein the oxidizing of the rare earth carbonates comprises calcination of the rare earth carbonates.

63. The process of claim 62, wherein the calcination is performed at temperatures between about 500 °C and about 1200 °C.

64. The process of claim 50, wherein the selectively separating the rare earth oxides is performed by at least one of solvent extraction, magnetic separation, or electrostatic separation.

65. The process of any one of claims 49 to 64, wherein the rare earth element-containing material comprises rare-earth element bearing ore materials, mine tailings, waste coal ash, or industrial waste materials.

66. The process of any one of claims 49 to 65, wherein the acidic solution is at least one of a sulfuric acid solution, a hydrochloric acid solution, a nitric acid solution, a carbonic acid solution, or a combination of any thereof.

67. The process of any one of claims 49 to 66, wherein the radionuclide salt is at least one of thorium sulfate, uranium sulfate, thorium chloride, uranium chloride, thorium nitrate or uranium nitrate, and hydrates thereof.

68. The process of any one of claims 49 to 67, further comprising removing phosphates from the pregnant solution.

69. The process of claim 68, wherein phosphate removal is performed by raising the pH of the substantially radionuclide depleted acidic solution to not greater than 3 to avoid precipitation of the radionuclide salt from the pregnant solution.

70. The process of claim 54, wherein the gangue material comprises at least one of iron, silicon, tin, phosphate or tantalum.

71. The process of any one of claims 49 to 70, wherein the sonication is performed using an external sonication probe.

72. The process of any one of claims 49 to 70, wherein the sonication is performed using an internal sonication probe.

73. A process for extracting one or more rare earth elements from a rare earth element-containing material, the process comprising:
processing the rare earth element containing material producing a processed material;
leaching the processed material in an acidic solution while simultaneously sonicating the acidic solution thereby producing a pregnant solution;
raising the pH of the pregnant solution to about 3 providing for the precipitation of a radionuclide salt from the pregnant solution and producing a substantially radionuclide depleted pregnant solution;
raising the pH of the substantially radionuclide depleted pregnant solution to about 9 and treating the solution with a source of carbonate to provide a precipitate comprising one or more rare earth carbonates;
oxidizing the one or more rare earth carbonates producing one or more rare earth oxides; and
selectively separating the one or more rare earth oxides.

74. The process of claim 73, wherein the sonication is performed at a frequency ranging from about 20 to about 200 kHz and an amplitude ranging from 1% to 100%.

75. The process of claim 73 or 74, wherein the leaching is performed at temperatures between about 20 °C and about 200 °C.

76. The process of any one of claims 73 to 75, wherein the radionuclide is at least one of thorium or uranium.

77. The process of any one of claims 73 to 76, wherein the processing comprises subjecting the rare earth element-containing material to at least one beneficiation step prior to the leaching to remove any gangue material.

78. The process of claim 77, wherein the at least one beneficiation step comprises separation based on optical and magnetic properties, sensor-based sorting, flotation, gravity separation, and comminuting, crushing or grinding.

79. The process of any one of claims 73 to 78, further comprising separating the rare earth carbonates into light and heavy rare earth carbonates.

80. The process of claim 79, wherein the light rare earth carbonates comprise Y₂(CO₃)₃, La₂(CO₃)₃, Ce₂(CO₃)₃, Pr₂(CO₃)₃, and hydrates thereof.

81. The process of claim 80, wherein the heavy rare earth carbonates comprise Yb₂(CO₃)₃, Nd₂(CO₃)₃, Sm₂(CO₃)₃, Dy₂(CO₃)₃, Gd₂(CO₃)₃, Er₂(CO₃)₃, and hydrates thereof.

82. The process of any one of claims 79 to 81, wherein the separating is performed by centrifugation.

83. The process of any one of claims 73 to 82, wherein the source of carbonate comprises CO₂ gas or a carbonate salt.

84. The process of claim 83, wherein the carbonate salt is one or more of sodium carbonate (Na₂CO₃), lithium carbonate (Li₂CO₃), or calcium carbonate (CaCO₃).

85. The process of any one of claims 73 to 84, wherein the oxidizing of the rare earth carbonates comprises calcination of the rare earth carbonates.

86. The process of claim 85, wherein the calcination is performed at temperatures between about 500 °C and about 1200 °C.

87. The process of any one of claims 73 to 86, wherein the selectively separating the rare earth oxides is performed by at least one of solvent extraction, magnetic separation, or electrostatic separation.

88. The process of any one of claims 73 to 87, wherein the rare earth element-containing material comprises rare-earth element bearing ore materials, mine tailings, waste coal ash, or industrial waste materials.

89. The process of any one of claims 73 to 88, wherein the acidic solution is at least one of a sulfuric acid solution, a hydrochloric acid solution or a nitric acid solution, a carbonic acid solution, or a combination of any thereof.

90. The process of any one of claims 73 to 89, wherein the radionuclide salt is at least one of thorium sulfate, uranium sulfate, thorium chloride, uranium chloride, thorium nitrate or uranium nitrate, and hydrates thereof.

91. The process of any one of claims 73 to 90, further comprising removing phosphates from the pregnant solution.

92. The process of claim 91, wherein phosphate removal is performed by raising the pH of the pregnant solution to not greater than 3 to avoid precipitation of the radionuclide salt from the pregnant solution.

93. The process of claim 77, wherein the gangue material comprises at least one of iron, silicon, tin, phosphate or tantalum.

94. The process of any one of claims 73 to 93, wherein the sonication is performed using an external sonication probe.

95. The process of any one of claims 73 to 93, wherein the sonication is performed using an internal sonication probe.

96. The process of any one of claims 1 to 95, wherein the rare earth element is at least one of scandium (Sc), yttrium (Y), lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), Erbium (Er), thulium (Tm), ytterbium (Yb), or lutetium (Lu).

97. The process of claim 96, wherein the rare earth element-containing material may further comprise a transition metal.

98. The process of claim 96 or 97, wherein the rare earth element-containing material may further comprise an actinide metal.

99. The process of any one of claim 1 or 98, wherein the rare earth element-containing material comprises a monazite ore material, bastnasite ore material, apatite ore material, or any combination thereof.
